(19) United States
(12) Patent Application Publication
(10) Pub. No.: US 2002/0107664 A1
(43) Pub. Date: Aug. 8, 2002

(54) Service element in dispersed systems

(76) Inventors: Rodolfo Mann Pelz, Hannover (DE); Oliver Vogt, Hannover (DE)

Correspondence Address: KENYON & KENYON, ONE BROADWAY, NEW YORK, NY, 10004, US

(21) Appl. No.: 09/913,992

(22) PCT Filed: Dec. 13, 2000
(86) PCT No.: PCT/DE00/04442

(30) Foreign Application Priority Data
Dec. 21, 1999 (DE) 199 61 589.6

(51) Int. Cl. G21C 17/00; G06F 15/00

(52) U.S. Cl. 702/182

(57) ABSTRACT

Proposed is a service element (2, 15, 16) in a distributed system, the service element being used to configure, equip, and maintain components of the distributed system, and, if necessary, to perform an emergency function. The service element (2, 15, 16) detects new components, and integrates them into the system, or gives information regarding the configuration. In the case of an error in the software running on components that are detected by the service element (2, 15, 16), a software correction is carried out, if necessary. Using communication means (4, 22, 24), the service element (2, 15, 16) loads new software for the components. In the case of serious functional errors, the service element (2, 15, 16) contacts a service provider, using communication means.

### FIELD OF THE INVENTION

The present invention relates to a service element in distributed systems.

### BACKGROUND INFORMATION

Distributed systems are already well-known in various fields of application. Thus, there are distributed systems in motor-vehicle electronics, which include sensors, actuators, airbags, and an engine management system. In addition, there are distributed systems in the form of communication and information systems in the motor vehicle. Such systems have combinations of navigation devices, mobile radio-communications devices, digital radio-broadcasting receivers, other radio-based transceiver stations such as bluetooth, signal processing units, voice and video encoding and decoding, multimedia processors, and sound processors.

In industrial automation, there are distributed systems that include autonomous vehicles and production lines. In household electronics, i.e. utilities, distributed systems are used for intelligent and/or networked household devices.

### SUMMARY OF THE INVENTION

In contrast, the service element of the present invention and the distributed system of the present invention have the advantage that the service element is able to carry out configurations, upgrades, maintenance, and, if necessary, emergency functions on the components of the distributed system. Thus, the distributed system can automatically adjust to new conditions in an advantageous manner. As a result, the distributed system and, therefore, the device in which the distributed system is disposed, become less dependent on visits to the work shop, and bringing in a specially trained service technician. This considerably simplifies the operation of distributed systems, which thereby acquire an additional measure of intelligence.

In this context, the operation by a user is considerably simplified, so that the training of the users can be reduced to a minimum. In particular, maintenance work can be advantageously carried out by the user alone, so that the distributed system acquires a high degree of independence.

It is particularly advantageous, that the service element of the present invention detects new components of the distributed system, and automatically integrates and configures them into the distributed system, or, if this is not possible, prompts a user to do this. This allows a newly added component to be quickly integrated in an advantageous manner.

In addition, it is advantageous that the service element of the present invention subjects the software running on the components of the distributed system to an error diagnosis and possibly corrects this software. In this manner, the available software is checked for errors by the user and, if necessary, is repaired. This saves the user a considerable amount of time.

A further refinement of the present invention provides for the service element of the present invention loading new software versions of software running on individual components of the distributed system, using a communication element available in the distributed system, and for the service element of the present invention initially checking the new software versions, in order to then configure them for the specific component. Consequently, the user is freed from the work-intensive updating of the software, which is often done in short intervals. This saves a considerable amount of work.

Furthermore, it is advantageous that the service element of the present invention allows a service provider to perform a remote diagnosis of faulty components, if the service element itself can no longer carry out a correction. This advantageously frees the user from contacting an external service in response to a fatal error, in order to eliminate this error. This considerably reduces expenditure.

In addition, it is advantageous that the service element of the present invention transfers information regarding the state of the distributed system to a user, using a display of a component in the distributed system. Consequently, the user is continuously informed about the state of the distributed system, and, if necessary, about actions that he or she must carry out himself or herself.

### BRIEF DESCRIPTION OF THE DRAWINGS

FIG. 1 shows a distributed system in the electronics of a motor vehicle, having the service element of the present invention.

FIG. 2 shows a distributed system in an information and entertainment system of a motor vehicle, having the service element of the present invention.

FIG. 3 shows a distributed system in household utilities, having the service element of the present invention.

### DETAILED DESCRIPTION

As mentioned above, distributed systems are being used more and more in various fields of application in engineering. In this context, some of these distributed systems do not have a central unit controlling the overall distributed system. This means that the individual components of the distributed system are independent in themselves. Therefore, an error diagnosis is either left to the component itself, or a user must take appropriate measures.

Thus, the present invention provides for a service element being used, which automatically configures components, performs maintenance tasks, and, in particular, updates individual components with new software versions, and, if necessary, automatically executes an emergency function as well, without the user having to intervene. In this context, the service element of the present invention is itself an independent component of the distributed system, the component either being provided with its own hardware, i.e. its own processor, or running on an already existing processor, in parallel with other software, if this processor allows another component to do this. If other software runs on the processor, then the software of the service element is run in certain time segments, which are either predefined or result from the pauses of the parallelly running software.

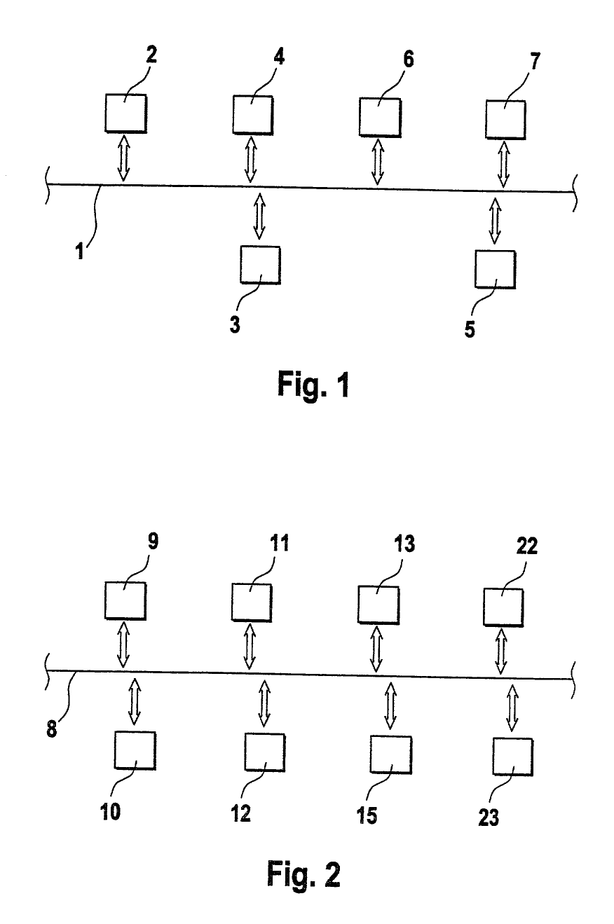

A distributed system having service element 2 of the present invention is represented in FIG. 1. In this case, the distributed system is in the electronics of a motor vehicle. A bus 1 connects the various components, the individual components being independent from one another.

Bus 1 is realized here by an electrical wiring system. An optical wiring system is also a possible alternative, the components connected to the bus then having optocouplers, in order to convert electrical signals into optical signals, and vice versa. A radio-based bus represents a further alternative, each station that transmits or receives via the radio-based bus then having a transceiver station for transmitting and receiving radio signals.

Service element 2, a memory device 3, communication element 4, a navigation device 5, a DAB (digital audio broadcasting) receiver 6, and a display 7 are each connected to bus 1 by data inputs and outputs.

Memory device 3 is used to store data for the individual components, such as the navigation device, in order to, in this case, retrieve geographical data and also temporarily store received data, which are received by communication element 4 or DAB receiver 6. The components requiring data from memory device 3 fetch them from memory device 3, via bus 1. All of the components connected to bus 1 have a bus controller, in order to be able to communicate via bus 1.

In a motor vehicle, communication element 4 includes transceiver stations that communicate over radio channels. These transceiver stations include, in particular, mobile telephones such as GSM (global system for mobile communications) and/or UMTS (universal mobile telecommunication system) devices. GSM is a widespread digital, cellular, mobile radio-communications standard, which operates in time division multiplex. UMTS is a mobile radio-communications standard, in which interleaved coding is especially used. In interleaved coding, narrow-band signals to be transmitted are interleaved with a broadband codeword, a plurality of interleaved signals then being transmitted in the same frequency range, without the occurrence of cross-interference between the signals.

However, other methods of radio transmission can also be used here, the radio transmission methods being able to be land-based and/or satellite-based. Optical communication can also be used here.

Communication element offers a user the possibility of conducting conventional communications, such as telephone conversations and data transmissions, but they are also of particular use to service element 2, in order to load new software versions for the individual components of the distributed system, using these communication element 4.

In addition, service element 2 allows a service provider to carry out a remote diagnosis of the individual components, using communication element 4. This service provider can then test the individual components directly, using communication element 4 and service element 2.

Service element 2 also contacts the service provider, using communication element 4, when service element 2 can no longer eliminate an error itself. If the component in question can also no longer be repaired using the remote diagnosis of the service provider, then the service provider contacts the user of the distributed system, using communication element 4, in order to request that he or she visit a repair shop. Display 7 and/or communication element 4 is used for this. As an alternative, the audio playback of the car radio, which includes DAB receiver 6, can be used.

Navigation device 5 offers a user an optimum route for an established destination, and guides him or her there. To that end, navigation device 5 utilizes different possibilities for representation, which can be optical as well as acoustical. Optical representation options are provided by an arrow display, a two-dimensional map display, or even a perspective view of a scene through which the motor vehicle of the user is traveling. The user is acoustically given information about the direction, in which he or she is to drive.

DAB receiver 6 is a receiver for DAB (digital audio broadcasting) signals. DAB is a digital radio broadcasting method, in which, in addition to the actual audio program, other data information is transmitted. DAB is also particularly suited for the mobile receiver, since the characteristics of DAB are designed for mobile reception. By distributing the information on a plurality of carrier frequencies, where the information items on the different carrier frequencies do not mutually interfere with each other, a frequency-selective attenuation especially does not weaken the entire signal to such an extent that reception is no longer possible, but rather the frequency-selective attenuation only causes the information transmitted on the sharply attenuated frequency to be lost. Distributing the signals on different carrier frequencies is known as orthagonal frequency-division multiplex (OFDM). Transmission errors are corrected by error-correcting codes.

In the case of DAB, various transmission modes are possible for data. First of all, it is possible to transmit a data stream, which is known as stream mode in English. This mode is particularly suitable for transmitting video sequences in real time, because the data are not reformatted in blocks, but are rather in the form of a data stream.

Secondly, it is possible to transmit data in small blocks. The MOT (multimedia object transfer) protocol is used for this purpose. It allows the data to be split up into small blocks, which is then combined again in the receiver. In addition, the audio program is transmitted in a third mode.

Apart from DAB, other digital radio transmission methods, such as DVB (digital video broadcasting) and DRM (Digital Radio Mondial), are also suitable for such data transmission. The difference between these methods is essentially a different frame structure, a different bandwidth, and a transmission-frequency range different from DAB, but in this case, error-correcting codes and OFDM may also be used. Analog radio broadcasting methods occasionally have digital carriers, such as, e.g. the known radio data signal, which can also be used for such information transmission.

Display 7 is used to represent data demanded by the user, e.g. using DAB receiver 6, or from navigation device 5, but display 7 is also used to display information about service element 2 to the user. For example, this can include a malfunction or a necessary configuration, which can only be implemented manually. Display 7 can be a video screen; however, windshield projection or a retinal projector is also possible. Display 7 has an input device itself, e.g. a layer sensitive to contact, or at least a terminal, so that an input device can be connected. This allows the user to retrieve and input information.

In regular intervals, service element 2 checks the components, which are connected to bus 1, and to which service element 2 also belongs. Therefore, a self-diagnosis is also carried out. This self-diagnosis, which is performed by software, is carried out using a suitable method.

A method known for this is the checksum method. CRC (cyclical redundancy check) sums are calculated using code segments of the software, and are compared. In this manner, an incorrect code can be identified, and, if the remaining software of the service element has the independent capability, then the software can be repaired, e.g. by loading new software parts, so-called patches. In the case of serious software errors of service element 2, an emergency operation of service element 2 can ensure the correction. A functional test of the bus communication can be carried out using predefined signals, which are transmitted on the bus, and to which a certain response from the connected components is expected, this response being known to service element 2. This ensures that an error message of a subsystem is not lost due to a bus interruption.

If service element 2 detects an error, then service element 2 contacts a service provider, using communication element 4, in order to load corrected software and consequently configure the specific components of the distributed system. But if there is a hardware error, then service element 2 initially sends a message to a service provider, who then contacts the user, so that the components in question are replaced or repaired. This error diagnosis is conducted in certain time intervals, e.g. once a day or every week or once a month.

Service element 2 questions a service provider in certain time intervals, e.g. once a month, if new software versions are available for the individual components of the distributed system. If this is the case, the service element requests such a new software version, and then loads it using communication element 4. The new software version is tested for errors, using test vectors, and is then configured for the corresponding components. Such an upgrade is then automatically carried out by the visitor alone. A service provider can be the manufacturer of the specific software, or also the manufacturer of the components. It can also be a service company, which takes over the distribution of the software and the maintenance tasks.

Furthermore, service element 2 alternatively has an additional emergency function. This includes the complete failure of the distributed system, or service element 2 has sensors to detect an emergency situation, e.g. an accident. Such sensors can also check the condition of the user. One possibility is a video camera, which compares recorded images with images stored in memory device 3, in order to conduct an image analysis, so that, in the case of the user being attacked, an emergency call is immediately executed by service element 2. Another alternative is conducting a voice analysis, using a microphone, a speech processor, and a memory device, in order to conduct a condition analysis in combination with a video analysis, or using a voice analysis alone.

A distributed system having a service element 15 is represented in FIG. 2. The distributed system includes the components of the motor-vehicle electronics. The components are again connected by a bus 8. Sensors 9, actuating mechanisms 10, an engine control unit 11, an airbag 12, a driver-recognition system having locking system 13, a display 22, and communication element 23 belong to the components, which are connected to bus 8 via data inputs/outputs and have bus controllers. Of course, service element 15 also belongs to these components.

The functionality of service element 15 is the same as for the one described in FIG. 1. Sensors 9 include speed sensors, temperature sensors for controlling an air conditioner, and tire sensors for controlling the operating dynamics. A slight deterioration of the operability of the components listed here has especially far-reaching implications on the safety of the motor vehicle. Therefore, it is important here, that service element 15 check the components frequently. An interface to a bus on which a communication element and a display are also already present, as is the case with the bus described in FIG. 1, is especially useful, because components necessary for the service element only have to be present in singlet. In addition, only one service element needs to be present.

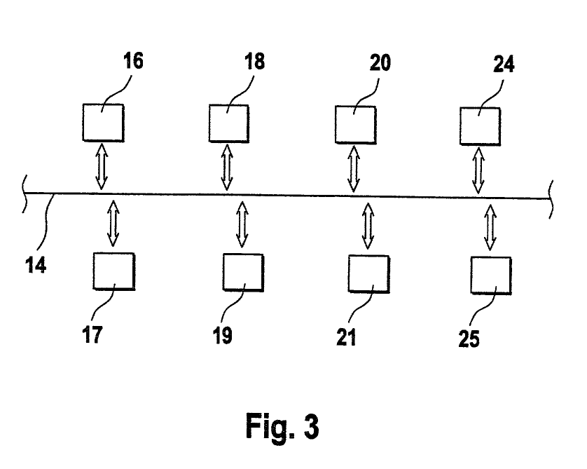

A further exemplary embodiment of a distributed system having service element 16 of the present invention is represented in FIG. 3. In this case, the distributed system is implemented in household utilities. The components are once again interconnected by a bus 14. In addition to service element 16, a heating unit 17, an air conditioner 18, a lighting system 19, a smoke alarm 20, a security system 21, a display 24, and communication element 25 are connected to bus 14. The functionality of service element 16 is again identical to the one described in FIG. 1. In this case, communication element 25 is an interface to a fixed telephone network, but the above-mentioned air interfaces are also possible. Display 24 will already be present in a distributed system for the household utilities, in order to allow the individual components to be checked and manually adjusted. In addition, an input device, by way of which a user can make inputs for information retrieval and configuration, is connected to display 24.

If the distributed systems do not have any communication element, the service element will only be able to, first of all, execute error messages and, secondly, carry out software repairs, using a display and the memory device.

What is claimed is:

1. A service element,
wherein the service element (2, 15, 16) is a component of a distributed system, the components of the distributed system being independent of one another and interconnected by a bus (1, 8, 14), and the service element (2, 15, 16) configures, equips, and maintains other components of the distributed system and, if necessary, carries out an emergency function.

2. The service element as recited in claim 1,
wherein the service element (2, 15, 16) detects new components and integrates them into the system, or the service element (2, 15, 16) represents information about a configuration, using a display (7, 22, 24).

3. The service element as recited in claim 2,
wherein the service element (2, 15, 16) carries out an error diagnosis of software running on the other components, and, in the case of an error, corrects the software within the framework of maintenance.

4. The service element as recited in claim 3,
wherein the service element (2, 15, 16) loads new software for the components, using communication means (4, 23, 25).

5. The service element as recited in claim 4,
wherein the service element (2, 15, 16) allows a remote diagnosis of components of the distributed system.

6. The service element as recited in claim 5,
wherein, in the case of a serious functional error, the service element (2, 3, 15) contacts a service provider, using the communication means (4, 23, 25).

7. The service element as recited in one of the preceding claims,
wherein the service element transfers to a user of the distributed system, using the display (7, 22, 24), the distributed system having the display (7, 22, 24) to the user as a component, which transfers information about the entire system to him or her.

8. The service element as recited in one of the preceding claims,
wherein the service element (2, 15, 16) checks newly loaded software, using predetermined values.

9. A distributed system, the distributed system having components independent of each other, and the components being connected by a bus (1, 8, 14),
wherein a service element (2, 15, 16) is a component of the distributed system, and the service element (2, 15, 16) configures, equips, and maintains other components of the distributed system and, if necessary, carries out an emergency function.

10. The distributed system as recited in claim 9,
wherein at least one component of the distributed system has communication means (4, 23, 25).
